(19) United States
(12) Patent Application Publication
(10) Pub. No.: US 2015/0139338 A1
(43) Pub. Date: May 21, 2015

(54) Identifying Leading Pictures in Video Coding

(71) Applicant: Telefonaktiebolaget L M Ericsson (publ), Stockholm (SE)

(72) Inventors: Jonatan Samuelsson, Stockholm (SE); Rickard Sjöberg, Stockholm (SE)

(73) Assignee: Telefonaktiebolaget L M Ericsson (publ), Stockholm (SE)

(21) Appl. No.: 14/398,283

(22) PCT Filed: May 3, 2013
(86) PCT No.: PCT/SE2013/050490

§ 371 Date: Oct. 31, 2014

Related U.S. Application Data
(60) Provisional application No. 61/641,953, filed on May 3, 2012.

(51) Int. Cl. H04N 19/169; H04N 19/172; H04N 19/89; H04N 19/463

(52) U.S. Cl. CPC H04N 19/188; H04N 19/463; H04N 19/172; H04N 19/89
USPC 375/240.26

(57) ABSTRACT

A method of encoding a video sequence is provided. The method (300) comprises including (301) Network Abstraction Layer (NAL) unit type information with each picture of the video sequence, and identifying (302) a current picture which is a leading picture of exactly one Clean Random Access (CRA) picture. The current picture is identified using the NAL unit type information, e.g., using a specific NAL unit type which is reserved for leading pictures of exactly one CRA picture. Further, a method of decoding a coded video sequence, a method of extracting a sub-bitstream from a coded video sequence, a method of processing a coded video sequence, corresponding computer programs and computer program products, a video encoder, a video decoder, and network elements are provided.

### TECHNICAL FIELD

The invention relates to a method of encoding a video sequence, a method of decoding a coded video sequence, a method of extracting a sub-bitstream from a coded video sequence, a method of processing a coded video sequence, corresponding computer programs and computer program products, a video encoder, a video decoder, and network elements.

### BACKGROUND

High Efficiency Video Coding (HEVC) is a new video coding standard currently being developed by the Joint Collaborative Team-Video Coding (JCT-VC). JCT-VC is a collaborative project between the Moving Picture Experts Group (MPEG) and the Telecommunication Standardization Sector of the International Telecommunication Union (ITU-T). Currently, a committee draft is defined that includes a number of new tools which makes HEVC considerably more efficient than prior art video coding standards, in particular H.264/AVC.

HEVC is hybrid video codec that uses multiple reference pictures for inter-prediction. Reference pictures are stored in a Decoded Picture Buffer (DPB) for use by subsequent pictures in the bitstream.

An HEVC coded bitstream, or coded video sequence, consists of one or more coded pictures, and each coded picture consists of one or more coded slices. Each slice is encapsulated in a Network Abstraction Layer (NAL) unit of a certain NAL unit type. Each picture in an HEVC coded bitstream is associated with an output order number, denoted Picture Order Count (POC) or PicOrderCntVal.

An access unit consists of one coded picture plus optionally some non-video-coding-layer data, i.e., parameters which may be used in the decoding process or for displaying.

Four types of pictures are defined in the HEVC standard: Instant Decoder Refresh (IDR), Clean Random Access (CRA), Temporal Layer Access (TLA), and regular pictures (non-IDR, non-CRA, and non-TLA).

Splicing is the action of taking data from two different bitstreams and composing it into one bitstream. Random access is the action of starting decoding from within the middle of a bitstream, i.e., discarding all access units up until the random access point. A problem with splicing and random access is that the element performing the action must make sure that the resulting bitstream is a conforming bitstream, i.e., that the resulting bitstream can be decoded.

IDR pictures remove all reference pictures from the DPB and are therefore easy to perform splicing and random access on. The reason for this is that no pictures which follow the IDR picture in decoding order can use any picture that preceded the IDR in decoding order. Decoding order is the order in which the pictures are processed in the decoding process. It is also the order of the pictures in the bitstream.

CRA pictures provide better coding efficiency than IDR pictures, but they do not remove all reference pictures from the DPB. Thus, CRA pictures are more complex for a unit operating on the bitstream, such as a decoder or a media aware network element, to perform splicing or random access on.

In the present context, a leading picture is defined as a picture that follows some other particular picture in decoding order and precedes it in output order. Output order is the order in which the decoded pictures are output from the DPB. It has been proposed to add a fifth type of pictures, referred to as Leading picture Following a CRA (LFC) picture or, alternatively, Leading Random Access (LRA) picture. The proposed picture type indicates that the picture is a leading picture of a CRA picture. Throughout this disclosure, the terms LRA and LFC are used synonymously.

A coded video sequence is defined as a sequence of access units which consists, in decoding order, of an IDR access unit followed by zero or more non-IDR access units, including all subsequent access units up to but not including any subsequent IDR access unit.

The term “directly follows in decoding order” is used to denote that there is no picture in-between the pictures in decoding order. That is, if picture A directly follows picture B in decoding order there cannot be any picture C which precedes picture A in decoding order but follows picture B in decoding order.

A problem of the prior art, and specifically the current HEVC specification, is that there is no process for performing random access into a bitstream. In particular, it does not defined how to perform splicing or random access for CRA pictures.

### SUMMARY

It is an object of the present invention to provide an improved alternative to the above techniques and prior art.

More specifically, it is an object of the present invention to provide an improved handling of leading pictures of CRA pictures.

These and other objects of the invention are achieved by means of different aspects of the invention, as defined by the independent claims. Embodiments of the invention are characterized by the dependent claims.

According to a first aspect of the invention, a method of encoding a video sequence is provided. The method comprises including NAL unit type information with each picture of the video sequence, and identifying a current picture which is a leading picture of exactly one CRA picture. The current picture is identified using the NAL unit type information.

According to a second aspect of the invention, a computer program is provided. The computer program comprises computer program code. The computer program code being adapted, if executed on a processor, to implement the method according to the first aspect of the invention.

According to a third aspect of the invention, a computer program product is provided. The computer program product comprises a computer readable storage medium. The computer readable storage medium has the computer program according to the second aspect of the invention embodied therein.

According to a fourth aspect of the invention, a method of decoding a coded video sequence is provided. The coded video sequence comprises NAL units. The method comprises detecting an error for a current picture based on NAL unit type information associated with the current picture. The NAL unit information of the current picture identifies the current picture as a leading picture of exactly one CRA picture.

According to a fifth aspect of the invention, a computer program is provided. The computer program comprises computer program code. The computer program code being adapted, if executed on a processor, to implement the method according to the fourth aspect of the invention.

According to a sixth aspect of the invention, a computer program product is provided. The computer program product comprises a computer readable storage medium. The computer readable storage medium has the computer program according to the fifth aspect of the invention embodied therein.

According to a seventh aspect of the invention, a method of extracting a sub-bitstream from a coded video sequence is provided. The video sequence comprises NAL units. The method comprises detecting a CRA picture in the coded video sequence, ignoring all NAL units preceding the identified CRA picture in decoding order, ignoring all NAL units until a NAL unit is detected which is not identified as a leading picture of exactly one CRA picture, and forwarding or decoding the resulting vide sequence. NAL units are identified as leading pictures of exactly one CRA picture using NAL unit type information.

According to an eighth aspect of the invention, a computer program is provided. The computer program comprises computer program code. The computer program code being adapted, if executed on a processor, to implement the method according to the seventh aspect of the invention.

According to a ninth aspect of the invention, a computer program product is provided. The computer program product comprises a computer readable storage medium. The computer readable storage medium has the computer program according to the eighth aspect of the invention embodied therein.

According to a tenth aspect of the invention, a method of processing a coded video sequence is provided. The video sequence comprises NAL units. The method comprises identifying a current picture which is a leading picture of exactly one CRA picture, and detecting an error if the NAL unit type information of the current picture is not set to a specific NAL unit type which is reserved for leading pictures of exactly one CRA picture.

According to an eleventh aspect of the invention, a computer program is provided. The computer program comprises computer program code. The computer program code being adapted, if executed on a processor, to implement the method according to the tenth aspect of the invention.

According to a twelfth aspect of the invention, a computer program product is provided. The computer program product comprises a computer readable storage medium. The computer readable storage medium has the computer program according to the eleventh aspect of the invention embodied therein.

According to a thirteenth aspect of the invention, a video encoder for encoding a video sequence is provided. The video encoder is arranged for including NAL unit type information with each picture of the video sequence, and identifying a current picture which is a leading picture of exactly one CRA picture. The current picture is identified using the NAL unit type information. An embodiment of the video encoder may, e.g., be located in a video camera or a device being arranged for providing a coded video bitstream such as a mobile phone, a tablet, a computer, or the like. More general, an embodiment of the encoder may be implemented in any entity which operates on a coded video sequence, i.e., a bitstream, e.g., a media aware network node.

According to a fourteenth aspect of the invention, a video decoder for decoding a coded video sequence is provided. The video sequence comprises NAL units. The video decoder is arranged for detecting an error for a current picture based on NAL unit type information associated with the current picture. The NAL unit type information of with the current picture identifies the current picture as a leading picture of exactly one CRA picture.

According to a fifteenth aspect of the invention, a network element for extracting a sub-bitstream from a coded video sequence is provided. The coded video sequence comprises NAL units. The network element is arranged for detecting a CRA picture in the coded video sequence, ignoring all NAL units preceding the identified CRA picture in decoding order, ignoring all NAL units until a NAL unit is detected which is not identified as a leading picture of exactly one CRA picture, and forwarding or decoding the resulting vide sequence. NAL units are identified as leading pictures of exactly one CRA picture using NAL unit type information. The network element may, e.g., be a network node for routing NAL units, such as a media-aware proxy.

According to a sixteenth aspect of the invention, a network element for processing a coded video sequence is provided. The coded video sequence comprises NAL units. The network element is arranged for identifying a current picture which is a leading picture of exactly one CRA picture, and detecting an error if the NAL unit type information of the current picture is not set to a specific NAL unit type which is reserved for leading pictures of exactly one CRA picture. The network element may, e.g., be a network node for routing NAL units, such as a media-aware proxy.

The present invention makes use of an understanding that coding of video sequences, and in particular the processes of splicing and random access, can be improved by imposing restrictions on leading pictures of CRA pictures. In that way, such leading pictures can easily be identified, and optionally discarded, e.g., when a sub-stream for random access is created. For that purpose, a specific NAL unit type, identifying the NAL units which are associated with a leading picture of exactly one CRA picture, may be defined and used. To this end, leading pictures of exactly one CRA picture are identified by setting the NAL unit type of the NAL units associated with the picture to a value which is reserved for leading pictures of exactly one CRA picture. Throughout this disclosure, such NAL unit type is sometimes referred to as “LRA” or “LFC” NAL unit type.

In this respect, it is proposed that leading pictures of a CRA picture, i.e., pictures which follow a CRA picture in decoding order and precede it in output order, should obey the following constraints:
They should be the first ones after the CRA in decoding order, and
They should use a reserved NAL unit type, such as LFC or LRA.

Further, a sub-bitstream which is created by removing all access units preceding a specific CRA access unit and the LFC, or LRA, access units of that CRA access unit should preferably be a conforming bitstream.

Imposing these constraints is advantageous since a processing unit performing splicing needs to know that no more leading pictures will appear later on. In addition, it should be easy to determine what pictures should be discarded when performing splicing.

It is further proposed that, if a bitstream starts with a CRA picture, there should be no leading pictures of that CRA.

With the proposed restrictions, splicing can always be performed by discarding the LRA NAL units of the CRA picture where the splicing is performed, without worrying of buffer overflow (or underflow), and without having to modify the bitstream or indicate any “broken-link”. Further, with the proposed restrictions decoding can always be performed from any random access point, i.e., CRA picture, by discarding the LRA NAL units of that CRA picture without worrying of buffer overflow (or underflow), and without requiring further modifications of the decoding process.

Embodiments of the invention are not limited to HEVC but may be applied to any extension of HEVC such as a scalable extension, a multi-view extension, or even to a different type video codec, i.e., other than HEVC.

According to an embodiment of the invention, the current picture is identified using the NAL unit type information if the current picture is a leading picture of exactly one CRA picture, and if the current picture directly follows in decoding order the exactly one CRA picture or, alternatively, if the current picture directly follows in decoding order a picture which is identified as a leading picture of the exactly one CRA picture.

According to an embodiment of the invention, a picture is identified as being a leading picture of exactly one CRA picture by setting the NAL unit type information of the picture to a specific NAL unit type which is reserved for leading pictures of exactly one CRA picture.

According to an embodiment of the invention, the NAL unit type information is included in the NAL unit headers of the NAL units which are associated with each picture.

According to an embodiment of the invention, an error is detected if the current picture is a leading picture of more than one CRA picture.

According to an embodiment of the invention, an error is detected if the current picture does not directly follow in decoding order the exactly one CRA picture or, alternatively, if the current picture does not directly follow in decoding order a picture which is identified as a leading picture of the exactly one CRA picture.

According to an embodiment of the invention, the current picture is identified as being a leading picture of exactly one CRA picture if the NAL unit type information of the current picture is set to a specific NAL unit type which is reserved for leading pictures of exactly one CRA picture.

Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, in which:

FIG. 1 shows a system for encoding, transporting, and decoding, of video signals.

FIG. 2 illustrates a NAL unit header, in accordance with an embodiment of the invention.

FIG. 3 shows a method of encoding a video sequence, in accordance with an embodiment of the invention.

FIG. 4 shows a method of decoding a coded video sequence, in accordance with an embodiment of the invention.

FIG. 5 shows a method of extracting a sub-bitstream from a coded video sequence and a method of processing a coded video sequence, in accordance with embodiments of the invention.

FIG. 6 illustrates a video encoder, in accordance with an embodiment of the invention.

FIG. 7 illustrates a video decoder, in accordance with an embodiment of the invention.

FIG. 8 illustrates a network element for extracting a sub-bitstream from a coded video sequence, in accordance with an embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

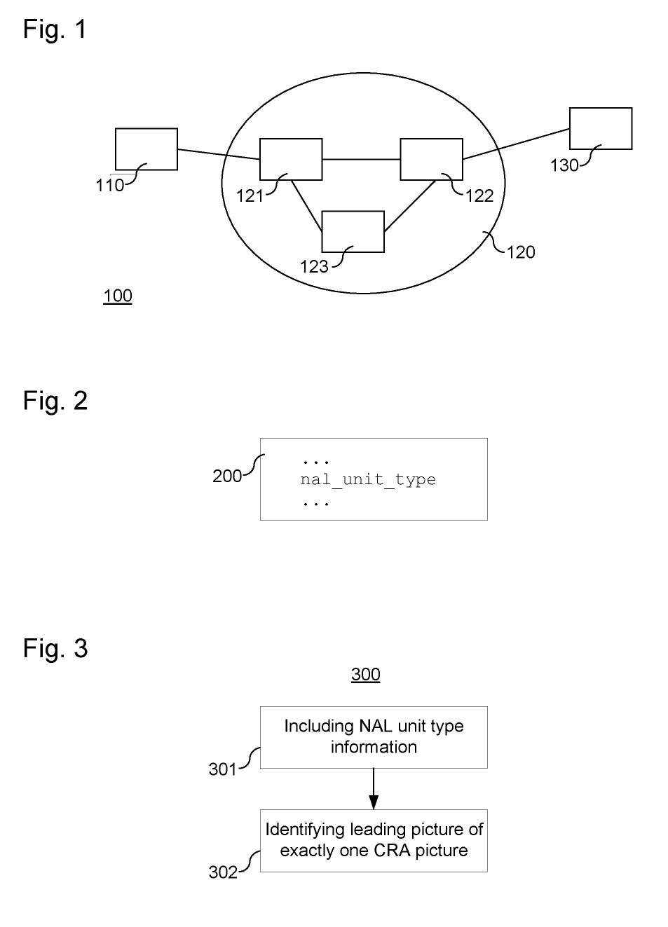

For the purpose of elucidating the invention, a system 100 for encoding, transporting, and decoding, video signals is illustrated in FIG. 1. System 100 comprises a video encoding device 110 (encoder), a transport network 120, and a video decoding device 130 (decoder). Typically, the encoder 110 receives a video signal from one or several sources and is arranged for compressing the video signal as well as sub-dividing the resulting bit stream into video packets, i.e., NAL units. The resulting video packets are then transported through transport network 120 to decoder 130. Transport network 120 typically comprises multiple interconnected nodes, i.e., network elements, 121-123 which are arranged for transporting video packets from encoder 110 to decoder 130. Network elements 121-123 may, e.g., be switches, routers, or any other type of network node suitable for processing video packets. Transport network 120 may, e.g., be a local area network, a mobile phone network, the Internet, or a combination thereof.

Decoder 130 is arranged for receiving video packets from transport network 120 and for decoding the received bitstream. Further, decoder 130 may be arranged for displaying the decoded video sequence to a viewer. Decoder 130 may, e.g., be a video player, a television set, a computer, or a mobile phone.

In FIG. 2, an example of a NAL unit header 200 is shown. NAL unit header 200 comprises an information element, or parameter, nal_unit_type which indicates the type of the corresponding NAL unit, i.e., whether the NAL unit contains coded video data, parameter sets, or the like. In addition to the parameter nal_unit_type, NAL unit header 200 may comprise further parameters not shown in FIG. 2, as is known in the art. In accordance with an embodiment of the invention, the information element nal_unit_type may acquire a value which is reserved for NAL units which are associated with leading pictures of exactly one CRA picture.

In FIG. 3, an embodiment of the method of encoding a video sequence is illustrated. Method 300 comprises including 301 NAL unit type information with each picture of the video sequence and identifying 302 a current picture which is a leading picture of exactly one CRA picture. The current picture is identified 302 as a leading picture of exactly one CRA picture using the NAL unit type information. That is, the parameter nal_unit_type, as described with reference to FIG. 2, is set to a reserved value which indicates that the corresponding NAL unit is associated with a leading picture of exactly one CRA picture. In other words, NAL units which are associated with a leading picture of exactly one CRA picture are marked as being of a specific NAL unit type. This is achieved by setting the parameter nal_unit_type to a reserved value.

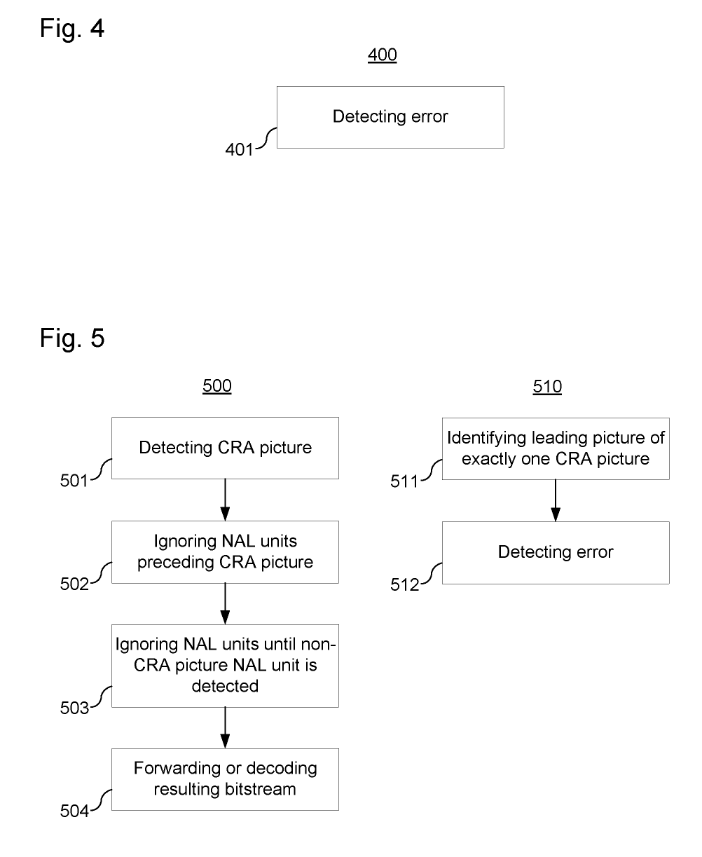

In FIG. 4, an embodiment of the method of decoding a coded video sequence comprising NAL units is illustrated. Method 400 comprises detecting 401 an error for a current picture based on NAL unit type information associated with the current picture. The NAL unit information of the current picture identifies the current picture as a leading picture of exactly one CRA picture. That is, the parameter nal_unit_type, as described with reference to FIG. 2, is set to a reserved value which indicates that the corresponding NAL unit is associated with a leading picture of exactly one CRA picture.

In FIG. 5, an embodiment of the method of extracting a sub-bitstream from a coded video sequence comprising NAL units is illustrated. Method 500 comprises detecting 501 a CRA picture in the coded video sequence, ignoring 502 all NAL units preceding the identified CRA picture in decoding order, ignoring 503 all NAL units until a NAL unit is detected which is not identified as a leading picture of exactly one CRA picture, and forwarding or decoding 504 the resulting video sequence. NAL units are identified as being associated with leading pictures of exactly one CRA picture using NAL unit type information, as was described hereinbefore

Further with reference to FIG. 5, an embodiment of the method of processing a coded video sequence comprising NAL units is illustrated. Method 510 comprises identifying 511 a current picture which is a leading picture of exactly one CRA picture and detecting 512 an error if the NAL unit type information of the current picture is not set to a specific NAL unit type which is reserved for leading pictures of exactly one CRA picture.

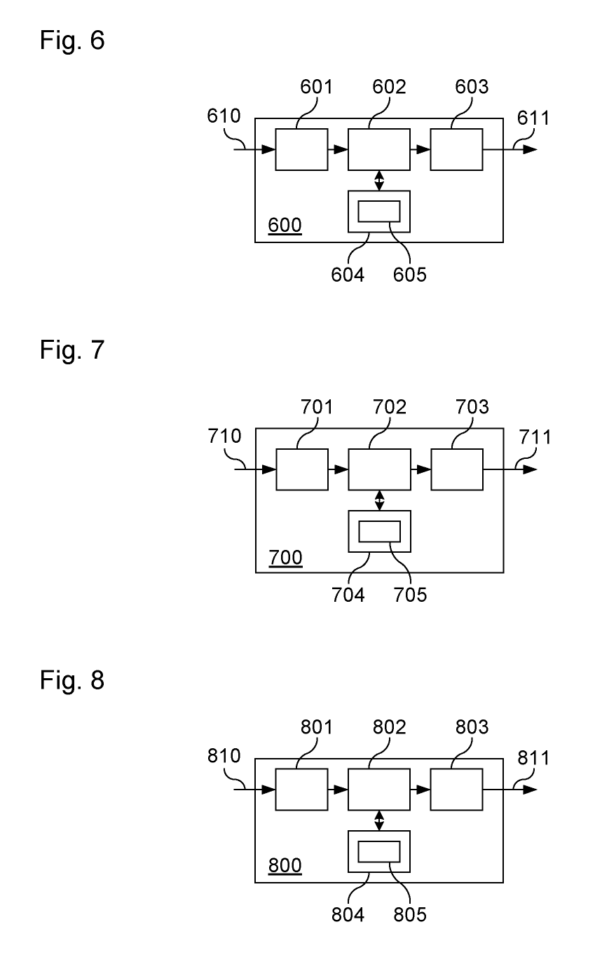

In FIG. 6, an embodiment of the video encoder is illustrated. Video encoder 600 comprises an input section 601, an output section 603, a processor 602, and a memory 604.

The encoder 600 receives a video 610, i.e., a sequence of pictures, via the input section 601, and the processor 602 is configured to perform the procedures disclosed herein. The output section 603 may provide the coded bitstream 611 for further processing or transport over a communications network, such as network 120 illustrated in FIG. 1. The functionality of the processor 603 may be realized by a computer program, i.e., software, 605 stored in the memory 604. The computer program 605 comprises computer program code which is adapted, when executed on the processor 602, to implement the procedures described herein, in particular with reference to FIG. 3.

An embodiment of the computer program 605 may be provided as a computer program product comprising a computer readable storage medium, which has the computer program 605 embodied therein. The computer readable storage medium may, e.g., be the memory 604, a memory stick, or any other type of data carrier. It will also be appreciated that an embodiment of the computer program 605 may be provided by means of downloading the computer program over a communication network.

In FIG. 7, an embodiment of the video decoder is illustrated. Video decoder 700 comprises an input section 701, an output section 703, a processor 702, and a memory 704.

The decoder 700 receives a bitstream 710 via the input section 701, and the processor 702 is configured to perform the procedures disclosed herein. The output section 703 provides the video 711 for further processing, e.g., displaying. The functionality of the processor 702 may be realized by a computer program, i.e., software, 705 stored in the memory 704. The computer program 705 comprises computer program code which is adapted, when executed on the processor 702, to implement the procedures described herein, in particular with reference to FIG. 4.

An embodiment of the computer program 705 may be provided as a computer program product comprising a computer readable storage medium, which has the computer program 705 embodied therein. The computer readable storage medium may, e.g., be the memory 704, a memory stick, or any other type of data carrier. It will also be appreciated that an embodiment of the computer program 705 may be provided by means of downloading the computer program over a communication network.

In FIG. 8, an embodiment of the network element is illustrated. Network element 800 comprises an input section 801, an output section 803, a processor 802, and a memory 804.

The network element 800 receives a bitstream 810 via the input section 801, and the processor 802 is configured to perform the procedures disclosed herein. The output section 803 provides the processed bitstream 811 for further transport. The functionality of the processor 802 may be realized by a computer program, i.e., software, 805 stored in the memory 804. The computer program 805 comprises computer program code which is adapted, when executed on the processor 802, to implement the procedures described herein, in particular methods 500 and 510 described with reference to FIG. 5.

An embodiment of the computer program 805 may be provided as a computer program product comprising a computer readable storage medium, which has the computer program 805 embodied therein. The computer readable storage medium may, e.g., be the memory 804, a memory stick, or any other type of data carrier. It will also be appreciated that an embodiment of the computer program 805 may be provided by means of downloading the computer program over a communication network.

In the following, further embodiments of the invention are described. Even though some of the embodiments are described with reference to one of the aspects of the invention, e.g., an encoder or a decoder, corresponding reasoning applies to embodiments of the other aspects of the invention.

In accordance with an embodiment of the invention, the LRA picture type is defined such that the LRA picture is the leading picture of one specific CRA picture. Optionally, the LRA picture type is defined such that the picture preceding the LRA picture in decoding order is either the CRA picture or another LRA picture of the CRA picture. Preferably, the LRA picture type is defined such that the picture is the leading picture of exactly one CRA picture.

In other words, an LRA picture is a coded picture for which each coded slice has nal_unit_type indicative of an “LRA picture” NAL unit type. For instance, nal_unit_type may be equal to 2. The LRA picture is a leading picture of exactly one CRA picture and the picture preceding the LRA picture in decoding order is either the CRA picture or another LRA picture of the CRA picture.

A decoder may be configured to perform the following steps:
1. A bitstream consisting of multiple NAL units is decoded.
2. If a picture contains one or more NAL units of nal_unit_type “LRA picture”, and the picture is the leading picture of more than one CRA picture, the decoder can interpret this as a bit-error, loss of data, or a non-compliant bitstream or encoder, respectively, and can take appropriate action, e.g., reporting the error or performing concealment. Alternatively, the decoder can ignore the LRA picture and continue decoding.

As an alternative, a decoder may be configured to perform the following steps.

1. A bitstream consisting of multiple NAL units is decoded.

2. If a picture contains one or more NAL units of nal_unit_type “LRA picture”, and that picture is not the leading picture of any CRA picture, the decoder can interpret that as a bit-error, loss of data, or a non-compliant bitstream or encoder, respectively, and can take appropriate action, e.g., reporting the error or performing concealment. Alternatively, the decoder can ignore the LRA picture and continue decoding.

As a further alternative, a decoder may be configured to perform the following steps:

1. A bitstream consisting of multiple NAL units is decoded.

2. If a current picture contains one or more NAL units of nal_unit_type “LRA picture”, and that picture is not preceded in decoding order by a CRA picture to which the current picture is a leading picture, or by an LRA picture which is a leading picture of a CRA picture to which the current picture is also a leading picture, the decoder can interpret that as a bit-error, loss of data, or a non-compliant bitstream or encoder, respectively, and can take appropriate action, e.g., reporting the error or performing concealment. Alternatively, the decoder can ignore the LRA picture and continue decoding.

An encoder may be configured to perform the following steps:

1. A video sequence is encoded into a conforming bitstream.

2. An “LRA picture” NAL unit type is selected for pictures only if they are leading pictures of exactly one CRA picture.

Optionally, these steps may be performed in a single operation.

Alternatively, an encoder may be configured to perform the following steps:

1. A video sequence is encoded into a conforming bitstream.

2. An “LRA picture” NAL unit type is selected for pictures only if they are leading pictures to exactly one CRA picture and directly follow the CRA in decoding order, or if they directly follow in decoding order an LRA picture which is a leading picture of the same CRA picture.

In accordance with another embodiment of the invention, there is a restriction on leading pictures of CRA pictures to the effect that they must be identified as LRA pictures using an “LRA picture” NAL unit type. In the prior art, such pictures can be identified as normal pictures or even CRA pictures.

The restriction can be formulated as follows (in relation to the HEVC standard, the “LRA picture” NAL unit types can be represented by a number, e.g., 2 or 15):

When the output order number which is associated with each picture in an HEVC coded bitstream, i.e., the POC (PicOrderCntVal) of the current picture is lower than the PicOrderCntVal of any CRA picture that precedes the current picture in decoding order, nal_unit_type of the current slice shall be equal to an “LRA picture” NAL unit type.

A decoder may be configured to perform the following steps:

1. A bitstream consisting of multiple NAL units is decoded.

2. If a picture contains leading pictures of a CRA picture which does not use an “LRA picture” NAL unit type, the decoder can interpret that as a bit-error, loss of data, or non-compliant bitstream or encoder, respectively, and take appropriate action, e.g., reporting the error or performing concealment. Alternatively, the decoder can ignore those leading pictures and continue decoding.

Optionally, these steps may be performed in a single operation.

An encoder may be configured to perform the following steps:

1. A video sequence is encoded to a conforming bitstream.

2. Each picture that is the leading picture of a CRA picture is encoded using a NAL unit type equal to “LRA picture”.

In accordance with a further embodiment of the invention, a sub-bitstream extraction process is defined for the purpose of random access. The process operates on a conforming bitstream and takes an indication of a random access point as input. Further, all NAL units preceding the random access point in decoding order shall be removed from the bitstream.

Further, if the random access point is a CRA picture then all leading pictures of that CRA picture, and all NAL units in their access units, shall be removed from the bitstream. Output of this process is a sub-bitstream.

To this end, the sub-bitstream is derived by removing from the bitstream:
all NAL units preceding a CRA in decoding order, and
all NAL units that belong to an access unit in which the coded picture is a leading picture of a CRA picture.

Preferably, any sub-bitstream which is created by removing such NAL units shall be a conforming bitstream.

Note that the leading pictures of a CRA access unit are easily identified as they are required to use a NAL unit type corresponding to an “LRA picture” NAL unit type (e.g., equal to 2), and as they are required to directly follow the CRA access unit in decoding order.

A decoder may be configured to perform the following steps:

1. A conforming bitstream is accessed, not necessarily from the beginning of the bitstream, e.g., through tuning in to a streaming coded sequence.

2. A CRA access unit is identified, e.g., by searching for NAL units with NAL unit type equal to “coded slice of a CRA picture”.

3. All NAL units preceding the identified CRA access unit in decoding order are ignored, i.e., removed from the bitstream and discarded.

4. All NAL units that belong to an access unit in which the coded picture is a leading picture of the identified CRA NAL unit are ignored, i.e., removed from the bitstream and discarded.

5. The resulting sub-bitstream is decoded.

Alternatively, a decoder may be configured to perform the following steps:

1. A conforming bitstream is accessed, not necessarily from the beginning of the bitstream, e.g., by tuning into a streamed coded sequence.

2. A CRA access unit is identified, e.g., by searching for NAL units with NAL unit type equal to “coded slice of a CRA picture”.

3. All NAL units preceding the identified CRA access unit in decoding order are ignored, i.e., removed from the bitstream and discarded.

4. Let access unit n be the n-th access unit in decoding order with the first access unit being access unit 0, and let access unit X be equal to the CRA access unit. Then, the following steps are performed until access unit X+1 does not contain an LRA picture:
a. increase X by one
b. mark all NAL units of access unit X as “to be removed from the bitstream”

5. All access units marked as “to be removed from the bitstream” are removed from the bitstream.

6. The resulting sub-bitstream is decoded.

An element operating on a bitstream may be configured to perform the following steps to deliver a conforming bitstream:

1. A conforming bitstream is received, not necessarily from the beginning of the bitstream, e.g., by tuning in to a streamed coded sequence.

2. A CRA access unit is identified, e.g., by searching for NAL units with NAL unit type equal to “coded slice of a CRA picture”.

3. All NAL units preceding the identified CRA access unit in decoding order are ignored, i.e., removed from the bitstream and discarded.

4. All NAL units that belong to an access unit in which the coded picture is a leading picture of the identified CRA NAL unit are ignored, i.e., removed from the bitstream and discarded.

5. The resulting sub-bitstream is forwarded.

Alternatively, an element operating on a bitstream may be configured to perform the following steps to deliver a conforming bitstream:

1. A conforming bitstream is received, not necessarily from the beginning of the bitstream, e.g., by tuning into a streamed coded sequence.

2. A CRA access unit is identified, e.g., by searching for NAL units with NAL unit type equal to “coded slice of a CRA picture”.

3. All NAL units preceding the identified CRA access unit in decoding order are ignored, i.e., removed from the bitstream and discarded.

4. Let access unit n be the n-th access unit in decoding order with the first access unit being access unit 0, and let access unit X be equal to the CRA access unit. Then the following steps are performed until access unit X+1 does not contain an LRA picture:
a. increase X by one
b. mark all NAL units of access unit X as “to be removed from the bitstream”.

5. All access units marked as “to be removed from the bitstream” are removed from the bitstream.

6. The resulting sub-bitstream is forwarded.

An element operating on multiple bitstreams may be configured to perform the following steps to perform splicing:

1. An appropriate point in a first bitstream, e.g., after the entire bitstream, is located and all NAL units, if any, following that point in decoding order are removed from the bitstream.

2. A CRA access unit is identified, e.g., by searching for NAL units with NAL unit type equal to “coded slice of a CRA picture” in a second bitstream.

3. All NAL units preceding the identified CRA access unit in decoding order in the second bitstream are ignored, i.e., removed from the bitstream and discarded.

4. The resulting second bitstream is concatenated with, i.e., the NAL units are added to, the first bitstream at the located point.

5. The concatenated bitstream is forwarded or decoded, depending on the type of element operating on multiple bitstreams.

An encoder may be configured to perform the following steps:

1. A video sequence is encoded to a conforming bitstream.

2. For each CRA access unit the encoder ensures, through proper selection of picture types, buffering period Supplemental Enhancement Information (SEI) parameters, and so forth, that the resulting bitstream, when applying the random access sub-bitstream extraction process, is a conforming bitstream.

In accordance with yet another embodiment of the invention, a coded video sequence is defined as a sequence of access units that consists, in decoding order, of an IDR access unit or a CRA access unit followed by zero or more non-IDR access units and non-CRA access units including all subsequent access units up to but not including any subsequent IDR access units or CRA access unit.

Preferably, if a bitstream starts with a CRA access unit, that CRA access unit cannot have any leading pictures. In other words, when the first access unit of the first coded video sequence in a bitstream is a CRA access unit, there shall be no leading pictures of that CRA access unit.

A decoder may be configured to perform the following steps:

1. A bitstream consisting of multiple NAL units is decoded.

2. If the first access unit in the bitstream is a CRA access unit, and the bitstream contains leading pictures of that CRA picture, the decoder can interpret that as a bit-error, loss of data, or non-compliant bitstream or encoder, respectively, and take appropriate action, e.g., reporting the error or performing concealment. Alternatively, the decoder can ignore those leading pictures and continue decoding.

An encoder may be configured to perform the following steps:

1. A video sequence is encoded into a conforming bitstream.

2. If there are leading pictures of the first picture in the bitstream, the NAL unit type is selected not to be “CRA picture”, i.e., “IDR picture” NAL unit type is selected. If there are no leading pictures, the “CRA picture” NAL unit type can be selected.

An element operating on multiple bitstreams may be configured to perform the following steps to perform splicing:

1. A first conforming bitstream is concatenated with a second conforming bitstream, without taking into account whether the first access unit in the second bitstream is a “CRA picture” NAL unit or an “IDR picture” NAL unit and, in the case of a CRA picture NAL unit, without taking into account if there are any leading pictures that need to be removed. The element operating on the bitstreams can perform the concatenation without checking the NAL unit type of the first access unit, since the bitstream requirements guarantee that, if the first access unit is a CRA picture, there are no leading pictures of the CRA picture.

5. The concatenated bitstream is forwarded or decoded, depending on the type of element operating on multiple bitstreams.

It will be appreciated that the embodiments presented hereinbefore may be combined. For instance, an encoder may be configured to perform the following steps:

1. A video sequence is encoded to a conforming bitstream.

2. A picture is encoded as having an “LRA picture” NAL unit type if and only if it is the leading picture of exactly one CRA picture and directly follows that CRA picture in decoding order, or directly follows another LRA picture which is the leading picture of the same CRA picture.

The person skilled in the art realizes that the present invention by no means is limited to the embodiments described above. On the contrary, many modifications and variations are possible within the scope of the appended claims.

1. A method of encoding a video sequence, the method comprising:
including Network Abstraction Layer (NAL) unit type information with each picture of the video sequence, and
identifying, using the NAL unit type information, a current picture which is a leading picture of exactly one Clean Random Access (CRA) picture.

2. The method according to claim 1, wherein the current picture is identified using the NAL unit type information if the current picture is a leading picture of exactly one CRA picture, and if the current picture directly follows in decoding order the exactly one CRA picture or a picture which is identified as a leading picture of the exactly one CRA picture.

3. The method according to claim 1, wherein a picture is identified as being a leading picture of exactly one CRA picture by setting the NAL unit type information of the picture to a specific NAL unit type which is reserved for leading pictures of exactly one CRA picture.

4. The method according to claim 1, wherein the NAL unit type information is included in the NAL unit headers of the NAL units which are associated with each picture.

5. A computer program product comprising a non-transitory computer readable medium storing computer program code, the computer program code being adapted, when executed on a processor, to implement the method according to claim 1.

6. A computer program product comprising a non-transitory computer readable medium storing computer program code, the computer program code being adapted, when executed on a processor, to implement the method according to claim 2.

7. A method of decoding a coded video sequence comprising Network Abstraction Layer (NAL) units, the method comprising:
detecting an error for a current picture based on NAL unit type information associated with the current picture and which identifies the current picture as a leading picture of exactly one Clean Random Access (CRA) picture.

8. The method according to claim 7, wherein an error is detected if the current picture is a leading picture of more than one CRA picture.

9. The method according to claim 7, wherein an error is detected if the current picture does not directly follow in decoding order the exactly one CRA picture or a picture which is identified as a leading picture of the exactly one CRA picture.

10. The method according to claim 7, wherein the current picture is identified as being a leading picture of exactly one CRA picture if the NAL unit type information of the current picture is set to a specific NAL unit type which is reserved for leading pictures of exactly one CRA picture.

11. The method according to claim 7, wherein the NAL unit type information is included in the NAL unit headers of the NAL units which are associated with the current picture.

12. A computer program product comprising a non-transitory computer readable medium storing computer program code, the computer program code being adapted, when executed on a processor, to implement the method according to claim 7.

13. A computer program product comprising a non-transitory computer readable medium storing computer program code, the computer program code being adapted, when executed on a processor, to implement the method according to claim 8.

14. A method of extracting a sub-bitstream from a coded video sequence comprising Network Abstraction Layer (NAL) units, the method comprising:
detecting a Clean Random Access (CRA) picture in the coded video sequence,
ignoring all NAL units preceding the identified CRA picture in decoding order,
ignoring all NAL units until a NAL unit is detected which is not identified, using NAL unit type information, as a leading picture of exactly one CRA picture, and
forwarding or decoding the resulting video sequence.

15. A method of processing a coded video sequence comprising Network Abstraction Layer (NAL) units, the method comprising:
identifying a current picture which is a leading picture of exactly one Clean Random Access (CRA) picture, and
detecting an error if the NAL unit type information of the current picture is not set to a specific NAL unit type which is reserved for leading pictures of exactly one CRA picture.

16. A video encoder for encoding a video sequence, the video encoder being arranged for:
including Network Abstraction Layer (NAL) unit type information with each picture of the video sequence, and
identifying, using the NAL unit type information, a current picture which is a leading picture of exactly one Clean Random Access (CRA) picture.

17. The video encoder according to claim 16, wherein the current picture is identified using the NAL unit type information if the current picture is a leading picture of exactly one CRA picture, and if the current picture directly follows in decoding order the exactly one CRA picture or a picture which is identified as a leading picture of the exactly one CRA picture.

18. The video encoder according to claim 16, wherein a picture is identified as being a leading picture of exactly one CRA picture by setting the NAL unit type information of the picture to a specific NAL unit type which is reserved for leading pictures of exactly one CRA picture.

19. The video encoder according to claim 16, wherein the NAL unit type information is included in the NAL unit headers of the NAL units which are associated with each picture.

20. A video decoder for decoding a coded video sequence comprising Network Abstraction Layer (NAL) units, the video decoder being arranged for:
detecting an error for a current picture based on NAL unit type information associated with the current picture and which identifies the current picture as a leading picture of exactly one Clean Random Access (CRA) picture.

21. The video decoder according to claim 20, wherein an error is detected if the current picture is a leading picture of more than one CRA picture.

22. The video decoder according to claim 20, wherein an error is detected if the current picture does not directly follow in decoding order the exactly one CRA picture or a picture which is identified as a leading picture of the exactly one CRA picture.

23. The video decoder according to claim 20, wherein the current picture is identified as being a leading picture of exactly one CRA picture if the NAL unit type information of the current picture is set to a specific NAL unit type which is reserved for leading pictures of exactly one CRA picture.

24. The video decoder according to claim 20, wherein the NAL unit type information is included in the NAL unit headers of the NAL units which are associated with the current picture.

25. A network element for extracting a sub-bitstream from a coded video sequence comprising Network Abstraction Layer (NAL) units, the network element being arranged for:
detecting a Clean Random Access (CRA) picture in the coded video sequence,
ignoring all NAL units preceding the identified CRA picture in decoding order,
ignoring all NAL units until a NAL unit is detected which is not identified, using NAL unit type information, as a leading picture of exactly one CRA picture, and
forwarding or decoding the resulting video sequence.

26. A network element for processing a coded video sequence comprising Network Abstraction Layer (NAL) units, the network element being arranged for:
identifying a current picture which is a leading picture of exactly one Clean Random Access (CRA) picture, and
detecting an error if the NAL unit type information of the current picture is not set to a specific NAL unit type which is reserved for leading pictures of exactly one CRA picture.
